(19) United States
(12) Patent Application Publication
(10) Pub. No.: US 2016/0334948 A1
(43) Pub. Date: Nov. 17, 2016

(54) IMAGE DISPLAY APPARATUS EQUIPPED WITH A TOUCH PANEL

(71) Applicant: CASIO COMPUTER CO., LTD., Tokyo (JP)

(72) Inventors: Kosuke MATSUMOTO, Tokyo (JP); Yoshitsugu MANABE, Tokyo (JP)

(73) Assignee: CASIO COMPUTER CO., LTD., Tokyo (JP)

(21) Appl. No.: 15/063,275

(22) Filed: Mar. 7, 2016

(30) Foreign Application Priority Data
May 15, 2015 (JP) 2015-099813

(51) Int. Cl. G06F 3/0482; G06F 3/0488; G06F 17/30; G06F 3/0484; H04N 5/232; G06F 3/041; G06F 3/0485

(52) U.S. Cl. CPC G06F 3/0482; G06F 3/0412; G06F 3/04883; G06F 3/0485; G06F 3/04842; H04N 5/23293; H04N 5/23216; G06F 17/30247; G06F 17/3028

(57) ABSTRACT

When a predetermined image switching operation is started, a control section refers to a judgment result as to whether a display portion specified in advance by a touch operation has been identified as a search target. If no display portion has been identified, the control section performs display control in response to the predetermined image switching operation such that images sequentially selected in a forward or reverse direction from a stored image group of images arranged according to a predetermined criterion are displayed on a display section. If a display portion has been identified as a search target, the control section performs display control such that a relevant search condition is acquired with reference to a search condition table based on the search target, the stored image group is searched for another image other than an image being displayed based on the search condition, and the found image is displayed.

### CROSS-REFERENCE TO RELATED APPLICATION

This application is based upon and claims the benefit of priority from the prior Japanese Patent Application No. 2015-099813, filed May 15, 2015, the entire contents of which are incorporated herein by reference.

### BACKGROUND OF THE INVENTION

1. Field of the Invention

The present invention relates to an image display apparatus equipped with a touch input section having a touch panel and a display section which displays an image, and a display control method.

2. Description of the Related Art

For example, in an image switching operation (image switching operation for sequentially switching images one by one) for this type of image display apparatus, a flick operation is performed on a touch panel laminated on a display section with a captured image being displayed on the display section. Then, based on the flick direction, the image is switched to the next image in a forward or reverse direction among a plurality of images arranged in the order of photographing date and time (stored image group). Although this image switching operation is easy to understand, if a large amount of captured images have been stored, finding a user-desired image by switching images one by one is burdensome, and takes time and effort.

In an image display apparatus according to a technology disclosed in Japanese Patent Application Laid-Open (Kokai) Publication No. 2010-244414, when the arrangement direction of a person's face in an image and a slide direction coincide with each other, all persons that are present on the side opposite to the slide direction are detected as search target persons. When the arrangement direction and the slide direction do not coincide with each other, all persons other than a person at a touched point are detected as search target persons. In this technology, search target persons are detected in accordance with a slide operation, and a search is made for other images showing the detected search target persons. Therefore, even if a large amount of images have been stored, a search can be easily made for a desired image, and an improvement in operability can be achieved.

### SUMMARY OF THE INVENTION

In accordance with one aspect of the present invention, there is provided an image display apparatus equipped with a touch input section having a touch panel and a display section which displays an image, comprising: a processor that is configured to: acquire a touched point when a touch operation is performed on the touch panel; identify a display portion corresponding to the acquired touched point in display data displayed on the display section, as a search target; judge whether a search target has been identified when a predetermined image switching operation is started; perform display control in response to the predetermined image switching operation such that images sequentially selected in a forward or reverse direction from a plurality of images arranged according to a predetermined criterion are displayed on the display section, when a judgment is made that no search target has been identified; and perform display control in response to the predetermined image switching operation such that another image other than the image being displayed is searched for from the plurality of images based on the identified display portion and displayed on the display section, when a judgment is made that a search target has been identified.

In accordance with another aspect of the present invention, there is provided an image display apparatus equipped with a touch input section having a touch panel and a display section which displays an image, comprising: a processor that is configured to: acquire a touch start point when a flick operation is performed on the touch panel; cause a display portion serving as a search target candidate in display data displayed on the display section to be displayed in a distinguishable manner; and search a plurality of images arranged according to a predetermined criterion in a search direction based on a flick direction of the flick operation with the display portion displayed in the distinguishable manner as a search target, when the acquired touch start point of the flick operation is the display portion displayed in the distinguishable manner.

In accordance with another aspect of the present invention, there is provided a display control method for an image display apparatus equipped with a touch input section having a touch panel and a display section which displays an image, comprising: acquiring a touched point when a touch operation is performed on the touch panel; identifying a display portion corresponding to the acquired touched point in display data displayed on the display section, as a search target; judging whether a search target has been identified when a predetermined image switching operation is started; performing display control in response to the predetermined image switching operation such that images sequentially selected in a forward or reverse direction from a plurality of images arranged according to a predetermined criterion are displayed on the display section, when a judgment is made that no search target has been identified; and performing display control in response to the predetermined image switching operation such that another image other than the image being displayed is searched for from the plurality of images based on the identified display portion and displayed on the display section, when a judgment is made that a search target has been identified.

In accordance with another aspect of the present invention, there is provided a display control method for an image display apparatus equipped with a touch input section having a touch panel and a display section which displays an image, comprising: acquiring a touch start point when a flick operation is performed on the touch panel; causing a display portion serving as a search target candidate in display data displayed on the display section to be displayed in a distinguishable manner; and searching a plurality of images arranged according to a predetermined criterion in a search direction based on a flick direction of the flick operation with the display portion displayed in the distinguishable manner as a search target, when the acquired touch start point of the flick operation is the display portion displayed in the distinguishable manner.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The present invention can be more deeply understood by the detailed description below being considered together with the following drawings.

FIG. 1 is a block diagram showing basic components of an imaging apparatus (digital camera) in which the present invention has been applied as an image display apparatus;

FIG. 2 is a diagram for describing image switching and display in accordance with an image switching operation (flick operation) in a playback mode;

FIG. 3A to FIG. 3C are diagrams for describing a special image switching operation (searching and switching operation) that is performed on a playback screen (touch panel) where an arbitrary image is being displayed;

FIG. 4A to FIG. 4D are diagrams for describing other examples of the special image switching operation (searching and switching operation);

FIG. 5 is a diagram for describing a search condition table 3c;

FIG. 6 is a flowchart of an operation that is started when switching to a playback mode is performed;

FIG. 7 is a flowchart for describing touch detection processing (Step A3 of FIG. 6) in detail;

FIG. 8 is a flowchart following the operation of FIG. 7;

FIG. 9 is a flowchart for describing in detail search acquisition processing (Step A5 of FIG. 6) related to images for a searching and switching operation;

FIG. 10 is a diagram of a modification example of the first embodiment, which shows a touch operation when a color is specified as a search target;

FIG. 11 is a diagram of another modification example of the first embodiment, which shows a name table;

FIG. 12 is a diagram outlining an operation in a search-switch mode in a second embodiment;

FIG. 13 is a flowchart of a characteristic operation in a playback mode in the second embodiment; and

FIG. 14 is a diagram for describing a modification example of the second embodiment.

### DETAILED DESCRIPTION OF THE PREFERRED EMBODIMENTS

Embodiments of the present invention will hereinafter be described in detail with reference to the drawings.

### First Embodiment

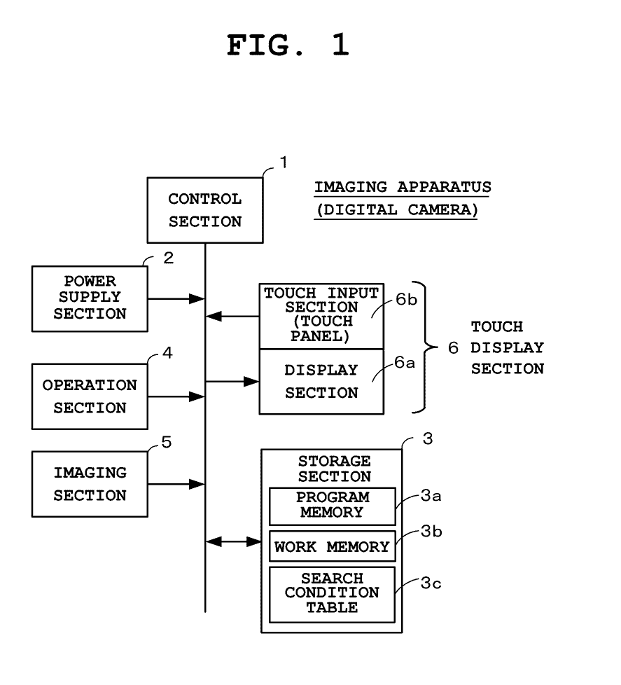

First, a first embodiment of the present invention is described with reference to FIG. 1 to FIG. 9.

FIG. 1 is a block diagram showing basic components of an imaging apparatus (digital camera) in which the present invention has been applied as an image display apparatus.

This imaging apparatus (digital camera) has an imaging function capable of photographing a photographic subject with high definition, a clock function which clocks a current date and time and timer time, an image playback function which reads out and replays an arbitrary photographed, recorded, and stored image (stored image), and the like. A control section 1 in FIG. 1 operates by power supply from a power supply section (secondary battery) 2, and controls the entire operation of the imaging apparatus by following various programs stored in a storage section 3. In the control section 1, a CPU (Central Processing Unit), a memory, and the like are provided, which are not depicted in the drawing.

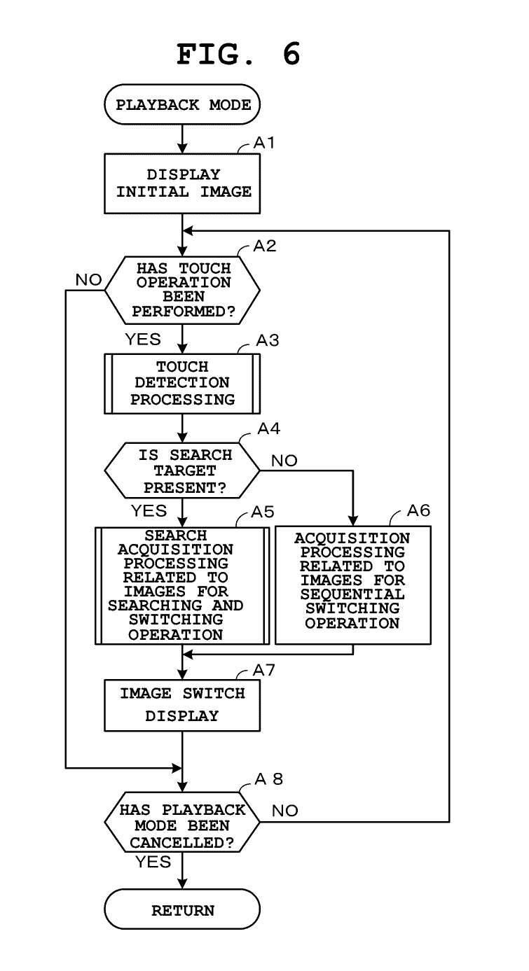

The storage section 3 is structured to have a ROM (Read Only Memory), a flash memory, and the like, and includes a program memory 3a where a program for achieving the present embodiment in accordance with an operation procedure depicted in FIG. 6 to FIG. 9 described later, various applications, and the like are stored, a work memory 3b for temporarily storing data such as a flag, a search condition table 3c described later, and the like. The storage section 3 may be structured to include, for example, a removable portable memory (recording medium) such as an SD (Secure Digital) card or an IC (Integrated Circuit) card capable of storing a plurality of photographed images (stored image group), or may be structured to include, although not shown, a storage area on a predetermined server apparatus side in a case where the camera is connected to a network by a communication function. The image memory such as an SD card can store a plurality of photographed images (stored images: still images) with high image quality. For example, information regarding a photographing date and time serving as a reference for arrangement in image switching is added to each of these stored images.

An operating section 4 in FIG. 1 includes, although omitted in the drawing, various hard keys such as a power supply key for power ON/OFF, a mode change key for switching between a photographing-enable mode and a mode for replaying a photographed image (stored image), a release key for giving an instruction for photographing, and a cross key. In response to an operation on one of these hard keys, the control section 1, for example, performs mode change processing, photographing processing, or the like. An imaging section 5 in FIG. 1 is capable of capturing a photographic subject with high definition by forming a subject image from an optical lens onto an imaging element (such as a CCD (Charge-Coupled Device) or a CMOS (Complementary Metal-Oxide Semiconductor)), although not depicted in the drawing. This imaging section 5 includes an imaging lens, the image element, various sensors, an analog processing section, and a digital processing section. An image photographed by the imaging section 5 is subjected to image compression processing by the control section 1 to be compressed as a file, and then recorded and stored in a recording medium in the storage section 3.

A touch display section 6 in FIG. 1 includes a display section 6a such as a high-definition liquid-crystal display or organic EL (Electro Luminescence) display for displaying an image and a touch input section 6b having a transparent touch panel. By the touch panel being arranged and laminated on the display section 6a, a touch screen is formed on which various software keys (icons and touch keys) are allocated and arranged, their function names are displayed, and a touch operation by a finger or the like is sensed to input an operation signal in response to the touch operation. The display screen of the touch display section 6 serves as a monitor screen for displaying a captured image (live view image) in real time or a playback screen for replaying an image photographed and stored.

In the touch input section 6b, for example, a capacitive type or resistance-film type is adopted. Based on a contact presence/absence signal (touch ON signal/touch OFF signal) from the touch input section 6b, the control section 1 detects a coordinate point (contact point) on the touch panel, a contact direction, a contact distance, and a contact time so as to judge the presence or absence of a touch operation, the type of the touch operation, and the operation contents. Here, examples of the type of the touch operation includes a single touch operation which is an operation of touching an arbitrary point on the touch panel with a finger or the like and soon releasing the finger; a flick operation which is an operation of touching the touch panel with a finger or the like, moving the finger in an arbitrary direction, and soon releasing the finger (sweeping operation); a multi-touch operation which is an operation of touching the touch panel with a plurality of fingers simultaneously and soon releasing the fingers; a pinch-in operation which is an operation of touching the touch panel with a plurality of fingers and then narrowing a space between or among the fingers; and a pinch-out operation which is an operation of touching the touch panel with a plurality of fingers and then widening a space between or among the fingers.

Note that the above-described touch operation is not limited to a contact operation of directly touching the touch input section 6b with a finger(s) or a pen. For example, an operation similar to the contact operation may be performed, which includes a proximity operation of detecting the position of a finger(s) or a pen in accordance with a change in capacitance due to the approach of the finger(s) or the pen and its approaching movement. That is, not only a touch-type touch panel for detecting a contact operation but also a proximity-type touch panel or device may be used. In the present embodiment, as a touch operation, a contact operation on a touch-type touch panel is exemplarily described.

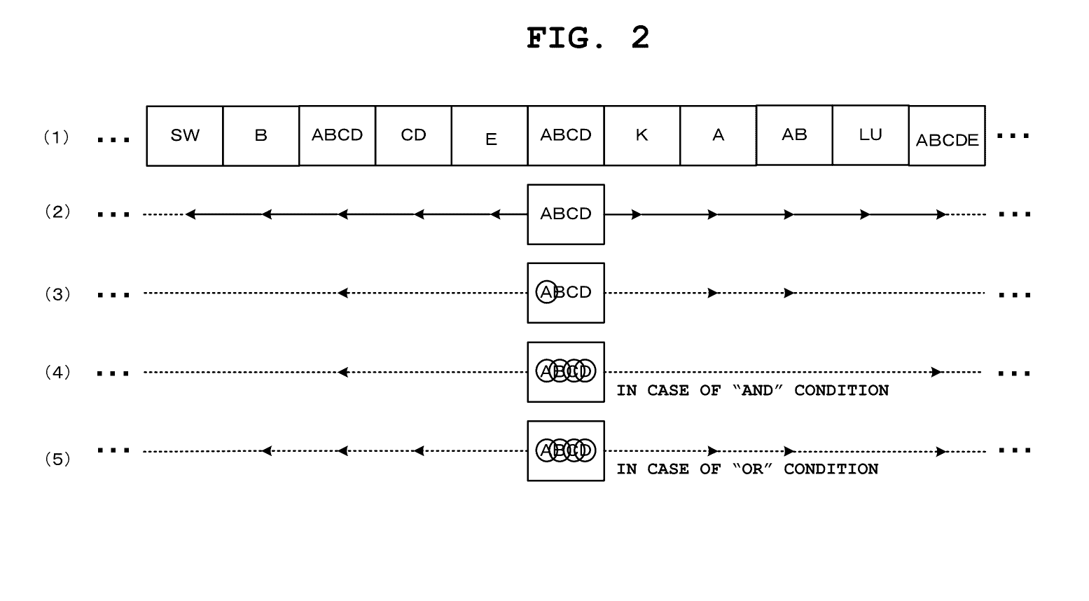

FIG. 2 is a diagram for describing image switching and display in accordance with a predetermined image switching operation (flick operation) in a playback mode.

Drawing (1) of FIG. 2 represents a plurality of photographed images (stored image group) arranged according to a predetermined criterion. In this stored image group, the images are arranged and managed, for example, in the order of photographing date and time, which is a predetermined criterion. To each stored image, information regarding a photographing date and time, a photographing place, and the like is added as related information (Exif information). In the drawing, “A”, “B”, “AB”, “ABCD”, and the like represent that one or more of persons A, B, C, and D are shown in that image. For example, when an image showing “ABCD” where four persons A, B, C, and D are included (group photograph) is being displayed on the display section 6a, if the imaging date and time of the displayed image showing “ABCD” is taken as a reference, stored images arranged leftward (backward) thereof are a group of images arranged in a reverse order in which an image with the oldest photographing date and time comes first, and stored images arranged rightward (forward) thereof are a group of images arranged in an order in which an image with the newest photographing date and time comes first.

Drawing (2) of FIG. 2 shows a state when a rightward (forward) flick operation (normal image switching operation) or a leftward (backward) flick operation (normal image switching operation) is performed on a playback screen (touch panel) where the image showing “ABCD” is being displayed. That is, drawing (2) of FIG. 2 represents normal image switching by a flick operation that switches the current image to the next image in the stored image group one by one in a forward direction or reverse direction for display. In the drawing, each arrow position represents the position of an image sequentially selected and displayed for each flick operation. For example, every time a leftward (backward) flick operation is performed, an image showing “E”, an image showing “CD”, an image showing “ABCD”, . . . are sequentially selected for switch display. Every time a rightward (forward) flick operation is performed, an image showing “K”, an image showing “A”, an image showing “AB”, . . . are sequentially selected for switch display.

Drawings (3) to (5) of FIG. 2 are diagrams for describing a state of image switching, each of which shows images searched for and displayed when a special image switching operation (searching and switching operation) for searching for a user-desired image and displaying the image (switch display) is performed instead of a normal image switching operation (sequential switching operation for each image) depicted in drawing (2) of FIG. 2. While the normal sequential switching operation is merely “flick operation”, the searching and switching operation is “touch operation for specifying a search target (specification touch operation)”+“flick operation”. In drawing (3) of FIG. 2, in order to specify an image showing person A as an image to be replayed next, person A is specified as a search target by a specification touch operation being performed on the playback screen (touch panel) where the image showing “ABCD” is being displayed.

When a predetermined image switching operation (flick) is performed with person A being specified as described above, the control section 1 searches the stored image group for an image containing the search target (person A). Here, based on the direction of the flick operation (flick direction), one of the arrangement directions (forward direction and reverse direction) of the stored image group is determined as a search direction, and the stored image group is searched for the image containing person A for switch display. In this case as well, each arrow position represents the position of an image to be displayed next. In the example depicted in the drawing, every time a leftward (backward) flick operation is performed, a current image is switched to the image showing “ABCD”, . . . , and so on. Every time a rightward (forward) flick operation is performed, a current image is switched to the image showing “A”, the image showing “AB”, . . . , and so on.

Drawings (4) and (5) of FIG. 2 show cases where the plurality of persons A, B, C, and D are specified by a specification touch operation being performed on the playback screen (touch panel) where the image showing “ABCD” is being displayed. Drawing (4) of FIG. 2 shows a case in which, as an image to be replayed next, an image containing all of the persons A, B, C, and D is taken as a search condition (logical AND:AND condition). In the example depicted in the drawing, every time a leftward (backward) image switching operation (flick operation) is performed, a current image is switched to the image showing “ABCD”, . . . , and so on. Every time a rightward (forward) image switching operation (flick operation) is performed, a current image is switched to the image showing “ABCDE”, . . . , and so on.

Drawing (5) of FIG. 2 shows a case where an image containing one of the plurality of persons A. B, C, and D is taken as a search condition (logical OR:OR condition). In the example depicted in the drawing, every time a leftward (backward) image switching operation (flick operation) is performed, a current image is switched to the image showing “CD”, the image showing “ABCD”, the image showing “B”, . . . , and so on. Every time a rightward (forward) image switching operation (flick operation) is performed, a current image is switched to the image showing “A”, the image showing “AB”, . . . , and so on. Note that whether the AND condition is enabled or the OR condition is enabled can be arbitrarily set in advance by a user operation when a plurality of search targets are specified.

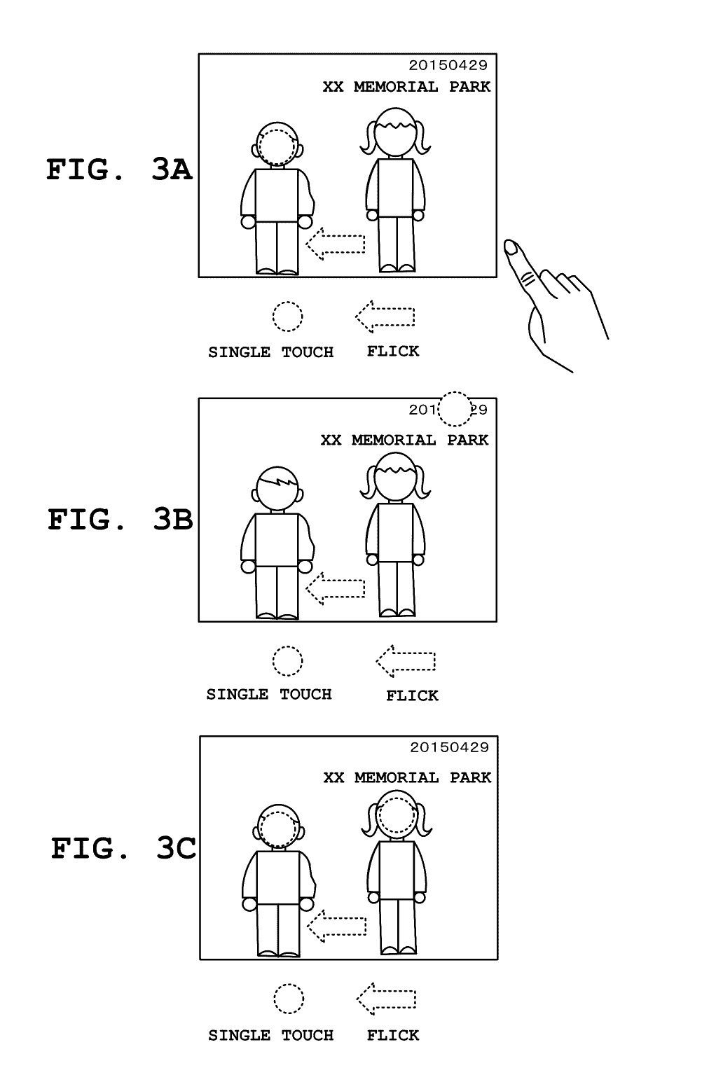

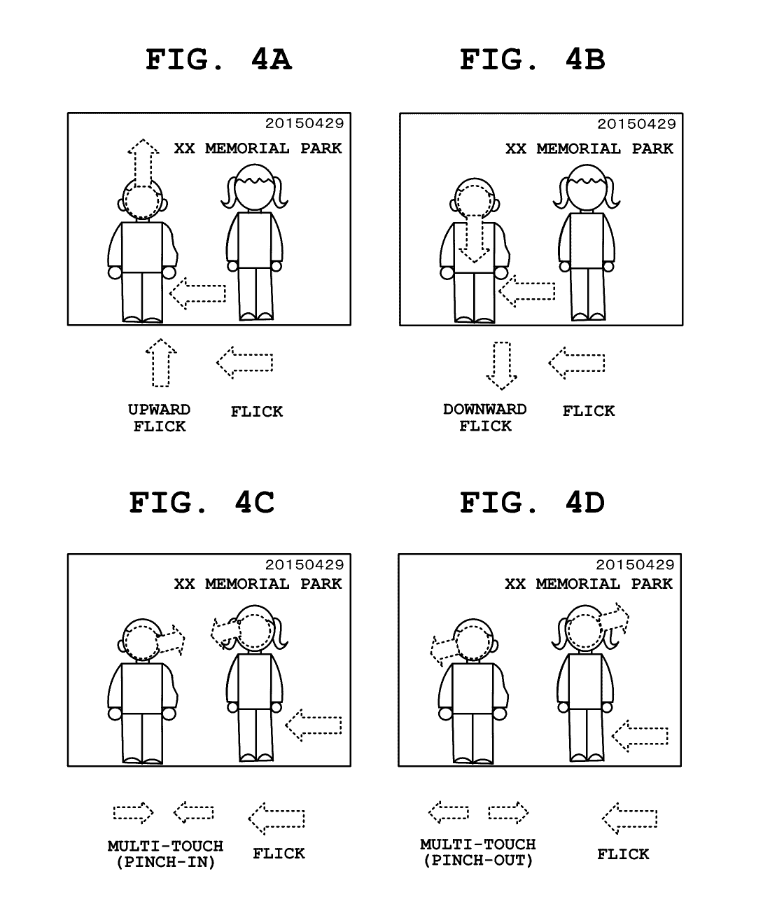

FIG. 3A to FIG. 3C and FIG. 4A to FIG. 4D are diagrams for describing a special image switching operation (searching and switching operation) that is performed on the playback screen (touch panel) displaying an arbitrary image (image of two persons, a male and a female).

FIG. 3A shows a case where the point of a user-desired search target (male face portion) is specified by a single touch operation with an arbitrary image being displayed on the playback screen so that the person is specified as a search target, and then an image switching operation (flick operation) is performed at an arbitrary point in an arbitrary direction (for example, leftward) on the playback screen. When this searching and switching operation (a touch operation of specifying a search target+a flick operation) is performed, the control section 1 searches a stored image group where images are arranged in the same direction as the direction of the flick operation as depicted in drawing (3) of FIG. 2 for an image containing the search target (the same person) for switch display.

FIG. 3B shows a case where a character string on OSD (On Screen Display) displayed on the playback screen is specified as a search target and an image switching operation (flick operation) is performed. In the example depicted in FIG. 3B, a single touch operation is performed on a character string portion of a photographing date and time serving as user-desired OSD so as to specify the point of a search target, and then a flick operation is performed at an arbitrary point in an arbitrary direction (for example, leftward) on the playback screen. When this searching and switching operation is performed, the control section 1 searches for an image photographed on the same day but on another month as an image containing the search target and performs switch display, as depicted in drawing (3) of FIG. 2. Note that this applies to not only the case where a character string portion of a photographing date and time is specified but also a case where a character string portion of another OSD (for example, imaging venue such as XX Memorial Park) is specified by a single touch operation as a search target. In this case as well, the control section 1 searches for an image photographed at the same place and performs switch display.

FIG. 3C shows a case where user-desired face portions of a plurality of persons (a male and a female) are individually touched each by a single touch operation so that the points of a plurality of search targets are specified, and then a flick operation is performed at an arbitrary point in an arbitrary direction (for example, leftward) on the playback screen. Here, if the above-described AND condition has been set when this searching and switching operation is performed, the control section 1 searches for an image containing all of the plurality of search targets (persons) for switch display, as depicted in drawing (4) of FIG. 2. If the OR condition has been set, the control section 1 searches for an image containing one of the plurality of persons serving as the search targets and performs switch display, as depicted in drawing (5) of FIG. 2. Note that the touch operation in FIG. 3C is not limited to a single touch operation of individually touching each of the face portions of the plurality of persons (a male and a female), and may be a multi-touch operation of simultaneously touching the face portions of the plurality of persons with a plurality of fingers.

FIG. 4A and FIG. 4B show cases where a flick operation is performed instead of a single touch operation as a touch operation for specifying a search target in more detail. FIG. 4A shows an upward flick operation, and FIG. 4B shows a downward flick operation. That is, in FIG. 4A, the point of the face of a person (male) desired by the user is specified at the touch start point of a flick operation, and an upward flick operation is performed from the specified point, whereby a search target with an additional search condition of “smile” is specified. Then, a flick operation is performed at an arbitrary point in an arbitrary direction (for example, leftward) on the playback screen.

In FIG. 4B, the point of the face of a person (male) desired by the user is specified at the touch start point of a flick operation, and a downward flick operation is performed from the specified point, whereby a search target with an additional search condition of “with eyes not closed” is specified. Then, a flick operation is performed at an arbitrary point in an arbitrary direction (for example, leftward) on the playback screen. As such, by using a flick operation to specify a search target instead of a single touch operation, an additional search condition such as “smile” or “with eyes not closed” is added to a desired person, whereby a search target can be specified in more detail. That is, a search target can be specified based on the touch start point of a flick operation, and an additional search condition for narrowing down the search target can be further specified based on the direction (for example, rightward or leftward) of the flick operation. Note that this additional search condition can be arbitrarily set by the user in association with a flick direction. Also, the flick direction is not limited to upward or downward, and may be leftward, rightward, or a diagonal direction.

FIG. 4C and FIG. 4D show cases where a pinch-in operation or a pinch-out operation is performed as a touch operation for specifying a search target in more detail. FIG. 4C shows a pinch-in operation, and FIG. 4D shows a pinch-out operation. That is, in FIG. 4C, the points of face portions of a plurality of persons (a male and a female) are specified with two fingers, and a pinch-in operation is performed in which the space between the two fingers is narrowed from the specified points. As a result, a search target is specified in more detail with an additional search condition “desired persons are close to each other” or the like. Then, a flick operation is performed at an arbitrary point in an arbitrary direction (for example, leftward) on the playback screen.

In FIG. 4D, the points of face portions of a plurality of persons (a male and a female) are specified with two fingers, and a pinch-out operation is performed in which the space between the two fingers is widened from the specified points. As a result, a search target is specified in more detail with an additional search condition “desired persons are away from each other” or the like. Then, a flick operation is performed at an arbitrary point in an arbitrary direction (for example, leftward) on the playback screen. As such, by using a pinch-in operation or a pinch-out operation to specify a search target, the search target can be specified in more detail. That is, a plurality of search targets are specified based on the touch start points of a pinch-in operation or a pinch-out operation, and an additional search condition for narrowing down the search targets is further specified based on the directions of the pinch-in operation or the pinch-out operation. Note that a multi-touch operation of specifying points with two fingers and soon releasing these fingers is regarded as an operation of specifying the points of a plurality of search targets without an additional search condition.

In the examples depicted in FIG. 4A and FIG. 4B, a person is specified as a search target and an additional search condition is added by a flick direction. However, the search target may be a photographing date and time, a photographing place, or the like. In this case, an additional search condition that is associated with a flick direction is set as appropriate. Also, in the examples depicted in FIG. 4C and FIG. 4D, a plurality of persons is specified as search targets. In the case where a plurality of search targets are specified, not only a combination of plural persons but also a combination of the faces of persons and a photographing place, a combination of the faces of persons and a photographing date and time, or a combination of a photographing date and time and a photographing place may be taken as a search condition. In this case, an additional search condition that is associated with a pinch-in/pinch-out operation is set as appropriate.

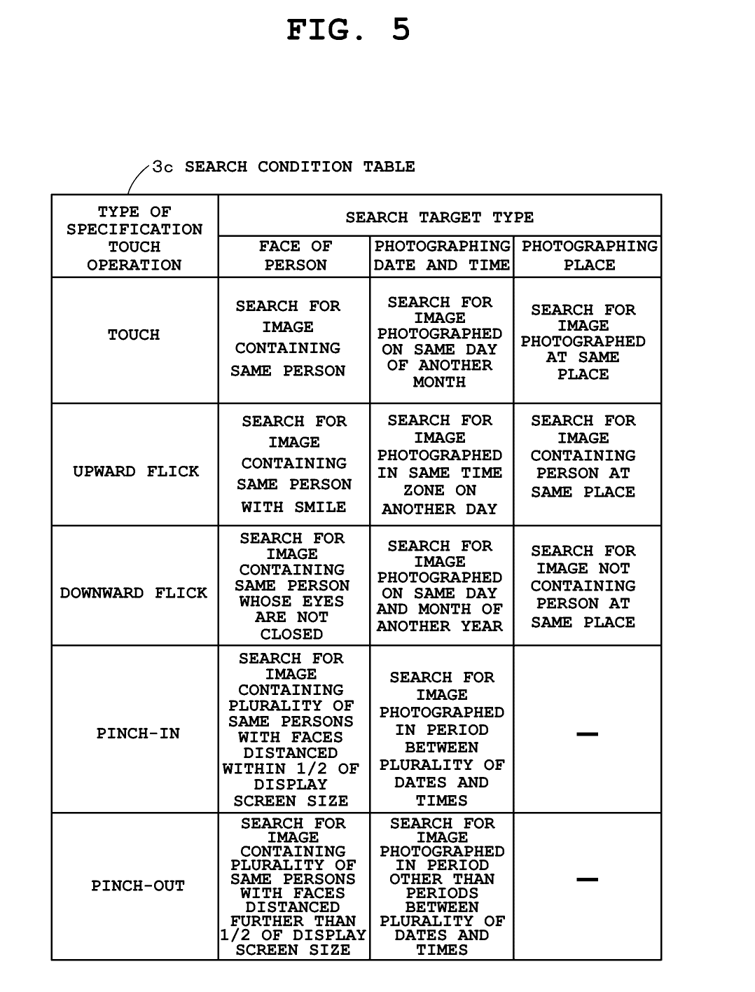

FIG. 5 is a diagram for describing a search condition table 3c.

The search condition table 3o is to store search conditions for searching for a user-desired image for playback in a playback mode, which includes fields of “type of specification touch operation” and “search target type”. “Type of specification touch operation” is a field for storing the type of a touch operation when a search target is specified, and has stored thereon one or a plurality of “touch(es)” of FIG. 3A to FIG. 3C, “upward flick” of FIG. 4A, “downward flick” of FIG. 4B, “pinch-in” of FIG. 4C, and “pinch-out” of FIG. 4D.

“Search target type” is a field for storing “face of person”, “photographing date and time”, and “photographing place” as a type that can be specified as a search target. In each “type of specification touch operation”, that is, in each of fields corresponding to “face of person”. “photographing date and time”, and “photographing place”, a search condition is stored for each specification touch operation and each search target. In the example depicted in the drawing, when “search target type” is “face of person”, “search for an image containing the same person” is stored as a search condition corresponding to “touch”, and “search for an image containing the same person with smile” is stored as a search condition corresponding to “upward flick”. In addition, “search for an image containing same person whose eyes are not closed” is stored as a search condition corresponding to “downward flick”, “search for an image containing plurality of same persons with faces distanced within ½ of display screen size” is stored as a search condition corresponding to “pinch-in”, and “search for an image containing plurality of same persons with faces distanced further than ½ of display screen size” is stored as a search condition corresponding to “pinch-out”.

When “search target type” is “photographing date and time”, “search for image photographed on same day of another month” is stored as a search condition corresponding to “touch”, “search for image photographed in the same time zone on another day” is stored as a search condition corresponding to “upward flick”, “search for image photographed on same day and month of another year” is stored as a search condition corresponding to “downward flick”. In addition, “search for image photographed in period between plurality of dates and times” is stored as a search condition corresponding to “pinch-in”, and “search for image photographed in period other than periods between plurality of dates and times” is stored as a search condition corresponding to “pinch-out”.

When “search target type” is “photographing place”, “search for image photographed at same place” is stored as a search condition corresponding to “touch”, “search for image containing person at same place” is stored as a search condition corresponding to “upward flick”, and “search for image not containing person at same place” is stored as a search condition corresponding to “downward flick”. Note that, although no search conditions have been set corresponding to “pinch-in” and “pinch-out” in the example depicted in the drawing, their search conditions may be set.

In the present embodiment, when a predetermined image switching operation (flick operation) is performed in the playback mode, whether to perform normal sequential switch processing of sequentially switching images one by one for switch display or search-switch processing of searching for a user-desired image for switch display is controlled. When an arbitrary display portion of display data (replayed image or OSD display) displayed on the touch display section 6 is subjected to a specification touch operation before an image switching operation (flick operation) is performed, if the display portion represents predetermined data (such as face of person, photographing date and time, or photographing place), the display portion is specified as a search target. Then, whether a search target has been specified is judged, and whether to perform normal sequential switch processing or to perform search-switch processing is controlled based on the judgment result.

That is, if no search target is specified when a predetermined image switching operation (flick operation) is performed, the control section 1 performs display control (normal sequential switch processing) by which images sequentially selected in a forward or reverse direction from a stored image group where images have been arranged according to a predetermined criterion are displayed on the display section 6a. If a search target is specified, the control section 1 performs display control (search-switch processing) of acquiring a relevant search condition with reference to the search condition table 3c based on the search target, searching the stored image group for an image other than the image being displayed based on the search condition, and displaying the found image on the display section 6a.

Next, the operation concept of the imaging apparatus (digital camera) in the first embodiment is described with reference to flowcharts depicted in FIG. 6 to FIG. 9. Here, each function described in the flowcharts is stored in a readable program code format, and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. This applies to other embodiments described later. Note that the flowchart in FIG. 6 outlines operations of the characteristic portion of the present embodiment from among all of the operations of the imaging apparatus (digital camera). After exiting the flow of FIG. 6, the procedure returns to the main flow (not shown) of the overall operation.

As described above, FIG. 6 is a flowchart of a characteristic operation, which is started when switching to the playback mode is performed.

First, when a previously displayed image is present, the control section 1 displays this image. When there is no previously displayed image, the control section 1 reads out a head image from a stored image group where images have been arranged according to a predetermined criterion, displays the read image on the playback screen (Step A1), and judges whether a touch operation has been performed (Step A2). When judged that a touch operation has not been performed (NO at Step A2), the control section 1 judges whether an operation for cancelling the playback mode has been performed (Step A8). When judged that an operation for cancelling the playback mode has not been performed (NO at Step A8), the control section 1 returns to Step A2 described above to judge whether a touch operation has been performed, enters a wait state for a touch operation, and repeats the above-described operations. Here, when a touch operation is detected (YES at Step A2), the control section 1 proceeds to touch detection processing (Step A3).

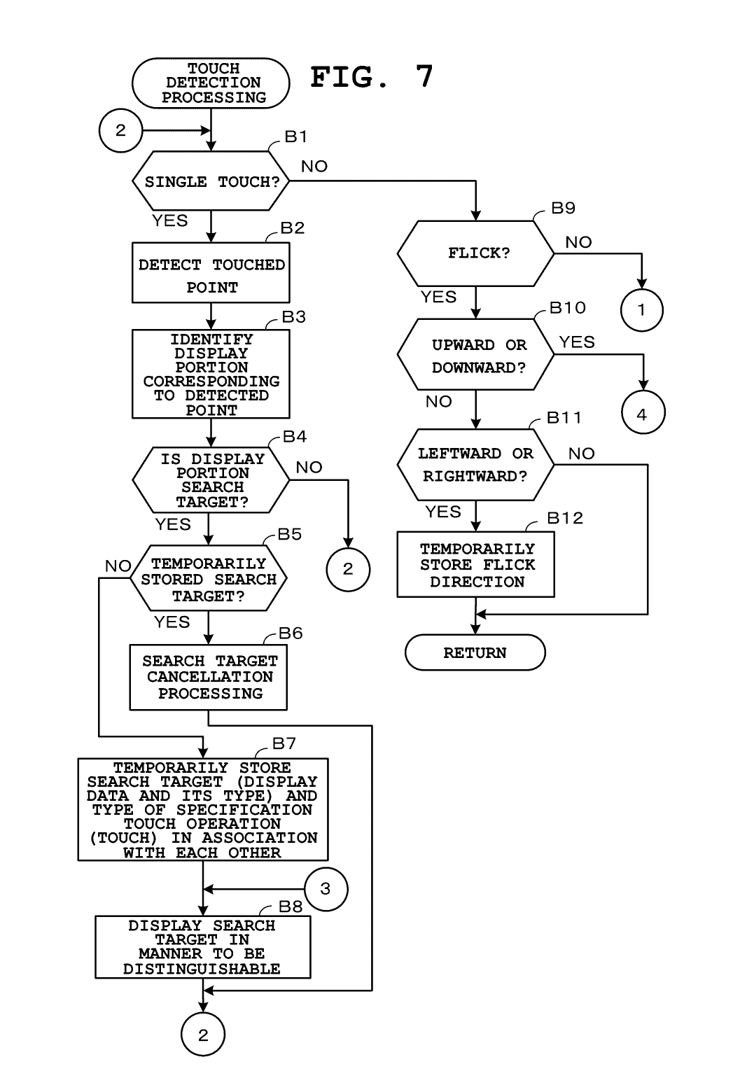

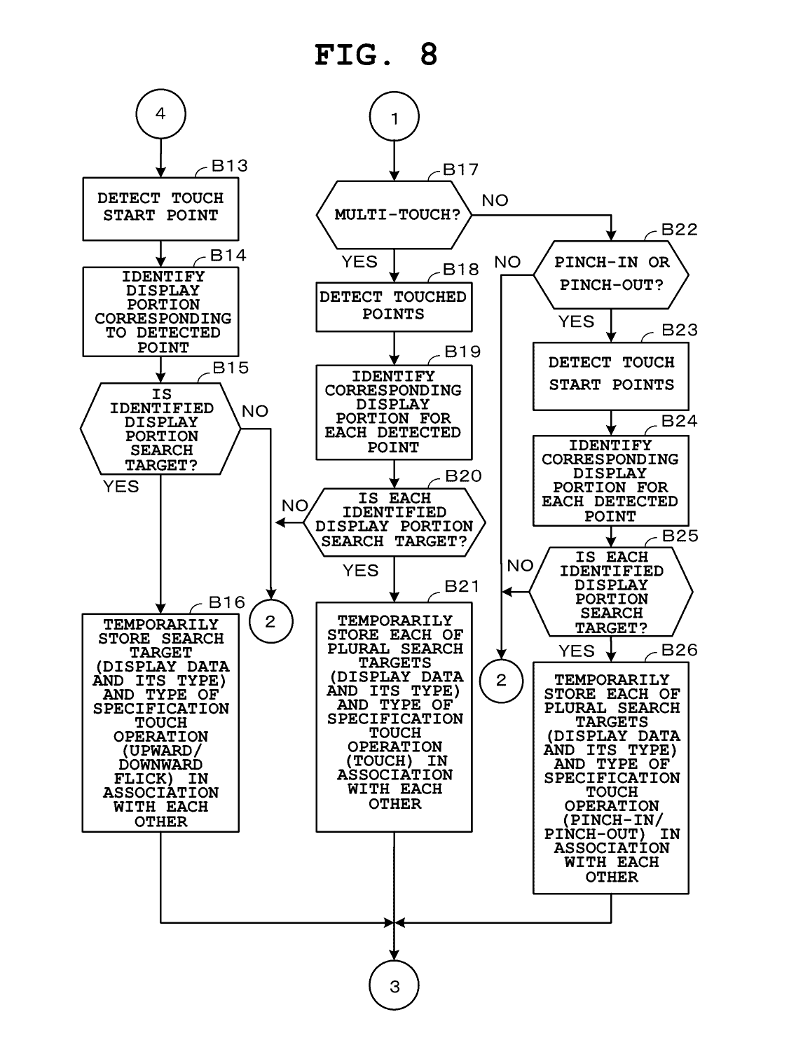

FIG. 7 and FIG. 8 are flowcharts for describing the touch detection processing (Step A3 of FIG. 6) in detail.

Here, when the touch operation is a single touch operation such as that depicted in FIG. 3A to FIG. 3C (YES at Step B1 of FIG. 7), the control section 1 regards the touch operation as a specification touch operation, detects the touched point (Step B2), and identifies a display portion corresponding to the detected point (Step B3). For example, in the case of FIG. 3A, the control section 1 identifies the face of a person (male) as a display portion corresponding to the touched point. In the case of FIG. 3B, the control section 1 specifies the character string of the photographing date and time.

Then, the control section 1 refers to the search condition table 3c based on the display portion corresponding to the touched point, and judges whether the display portion is a search target based on whether the display portion is predetermined data (face of person, photographing date and time, or photographing place) (Step B4). As a result, when the display portion is not a search target (face of person, photographing date and time, or photographing place) (NO at Step B4), the control section 1 returns to Step B1 described above to disenable this single touch operation. When the display portion is a search target (YES at Step B4), the control section 1 judges whether this is a case where a specified search target temporarily stored has been specified again (Step B5).

Here, at the first time immediately after the switching to the playback mode, no temporarily-stored search target is present (NO at Step B5). Therefore, the control section 1 temporarily stores this search target (display data and its type) and the type of the specification touch operation (touch) in the work memory 3b in association with each other (Step B7). In addition, by adding color, a bold line or the like to the display portion of the search target, the control section 1 displays the search target in a manner to be distinguishable (Step B8). Then, the control section 1 returns to Step B1 described above. Here, when a single touch operation is again detected (YES at Step B1), the control section 1 performs Steps B2 to B4 described above. Here, even when a display portion corresponding to the touched point is specified as a search target (YES at Step B4), if this display portion has been specified and temporarily stored as a search target (YES at Step B5), the control section 1 performs processing of deleting the display of the search target in a distinguishable manner so as to cancel the search target and also deleting the search target temporarily stored in the work memory 3b (Step B6), and then returns to Step B1 described above.

Also, when a single touch operation is again performed to newly add and specify another search target as depicted in FIG. 3C (YES at Step B1), the control section 1 additionally stores the newly specified search target (display data and its type) and the type of the specification touch operation (touch) in the work memory 3b in association with each other (Step B7) on condition that a display portion corresponding to the touched point is a search target (YES at Step B4) and the search target has not been specified and temporarily stored (NO at Step B5), and displays the display portion of the search target such that it is distinguishable (Step B8).

When the touch operation is a flick operation (YES at Step B9), the control section 1 judges whether the flick operation is an upward flick operation or a downward flick operation, that is, whether the flick operation has been performed as a specification touch operation for specifying a search target (Step B10). Here, when the flick direction is not upward or downward (YES at Step B9 and NO at Step B10) as depicted in FIG. 3A to FIG. 3C, the control section 1 proceeds to the next Step B11 to judge whether the flick operation is a leftward flick operation or a rightward flick operation, that is, whether a normal sequential switching operation has been performed. When the flick operation is a leftward flick operation or a rightward flick operation (YES at Step B11), the control section 1 temporarily stores the flick direction in the work memory 3b (Step B12), and then exits the flows of FIG. 7 and FIG. 8.

Conversely, when the flick direction is upward or downward as depicted in FIG. 4A and FIG. 4B (YES at Step B10), the control section 1 proceeds to Step B13 of FIG. 8 to detect its touch start point and identify a display portion corresponding to the detected point (Step B14). For example, the face portion of a person (male) is identified as this display portion as depicted in FIG. 4A and FIG. 4B. Then, the control section 1 judges whether the display portion is a search target with reference to the search condition table 3c (Step B15). When the display portion is not a search target (face of person, photographing date and time, or photographing place) (NO at Step B15), the control section 1 returns to Step B1 of FIG. 7 and enables this flick operation.

When the display portion is a search target (YES at Step B15), the control section 1 temporarily stores the search target (display data and its type) and the type of the specification touch operation (upward flick operation or downward flick operation) in the work memory 3b in association with each other (Step B16), and then proceeds to Step B8 of FIG. 7 to display the display portion of the search target in a manner to be distinguishable. In this case as well, when the specified display portion temporarily stored as a search target is again specified, processing of cancelling specification of the search target may be performed. Also, when the specified display portion temporarily stored is again specified but the type of the specification touch operation is different, the control section 1 may perform an update to the type of the new specification touch operation.

When the touch operation for specifying a search target is a multi-touch operation (YES at Step B17 of FIG. 8), the control section 1 regards the touch operation as a specification touch operation, detects each touched point of the multi-touch operation (Step B18), identifies a corresponding display portion for each detected point (Step B19), and judges whether each display portion is a search target (Step B20). Here, if any one of the display portions is not a search target (NO at Step B20), the control section 1 returns to Step B1 of FIG. 7 to disenable this multi-touch operation. When all of the display portions are search targets (YES at Step B20), the control section 1 temporarily stores each search target (display data and its type) and the type of the specification touch operation (touch) in the work memory 3b in association with each other (Step B21), and then proceeds to Step B8 of FIG. 7 to display the display portions of the search targets in a manner to be distinguishable.

In this case as well, when the specified display portion temporarily stored as a search target is again specified, processing of cancelling specification of the search target may be performed.

When the touch operation for specifying a search target is a pinch-in operation or a pinch-out operation such as those depicted in FIG. 4C and FIG. 4D (YES at Step B22 of FIG. 8), the control section 1 regards the touch operation as a specification touch operation, detects each start point of the multi-touch operation (Step B23), identifies a corresponding display portion for each detected point (Step B24), and judges whether each display portion is a search target (Step B25). Here, if any one of the display portions is not a search target (NO at Step B25), the control section 1 returns to Step B1 of FIG. 7 to disenable this multi-touch operation. When all of the display portions are search targets (YES at Step B25), the control section 1 temporarily stores each search target (display data and its type) and the type of the specification touch operation (pinch-in or pinch-out) in the work memory 3b in association with each other (Step B26), and then proceeds to Step B8 of FIG. 7 to display the display portions of the search targets in a manner to be distinguishable.

In this case as well, when the specified display portion temporarily stored as a search target is again specified, processing of cancelling specification of the search target may be performed. Also, when the specified display portion temporarily stored is again specified but the type of the specification touch operation is different, the control section 1 may perform an update to the type of the new specification touch operation.

When the touch detection processing (Step A3 of FIG. 6) ends as described above, the control section 1 proceeds to Step A4 of FIG. 6 to judge whether a search target has been stored in the work memory 3b, or in other words, judges whether a display portion corresponding to the touched point has been specified as a search target. That is, the control section 1 judges whether a normal sequential switching operation for sequentially switching and replaying images one by one has been performed or a special image switching operation (searching and switching operation) for searching for a user-desired image for replay has been performed.

Here, when no search target has been temporarily stored (NO at Step A4), or in other words, when no search target has been specified, the control section 1 judges that a normal sequential switching operation has been performed, and proceeds to the next Step A6 to perform processing for acquiring images for sequential switching. In this processing, the control section 1 acquires a flick direction from the work memory 3b, and reads out subsequent images arranged in the same direction as the flick direction one by one from the stored image group as depicted in drawing (2) of FIG. 2. When a search target has been temporarily stored in the work memory 3b (YES at Step A4), or in other words, when a search target has been specified, the control section 1 judges that a special image switching operation (searching and switching operation) has been performed, and performs search acquisition processing related to images for a searching and switching operation (Step A5) described later.

As described above, based on whether even one search target has been temporarily stored in the work memory 3b, the control section 1 judges whether a normal sequential switching operation has been performed or a searching and switching operation has been performed. As a result of this configuration, for example, even when a plurality of search targets have been stored in the work memory 3b by an operation of specifying these search targets, if all of the search targets are cancelled by subsequent cancelling operation (operation of re-specifying a specified search target) such that the number of search targets becomes zero, the control section 1 judges that a normal sequential switching operation has been performed, and proceeds to processing for acquiring images for sequential switching (Step A6).

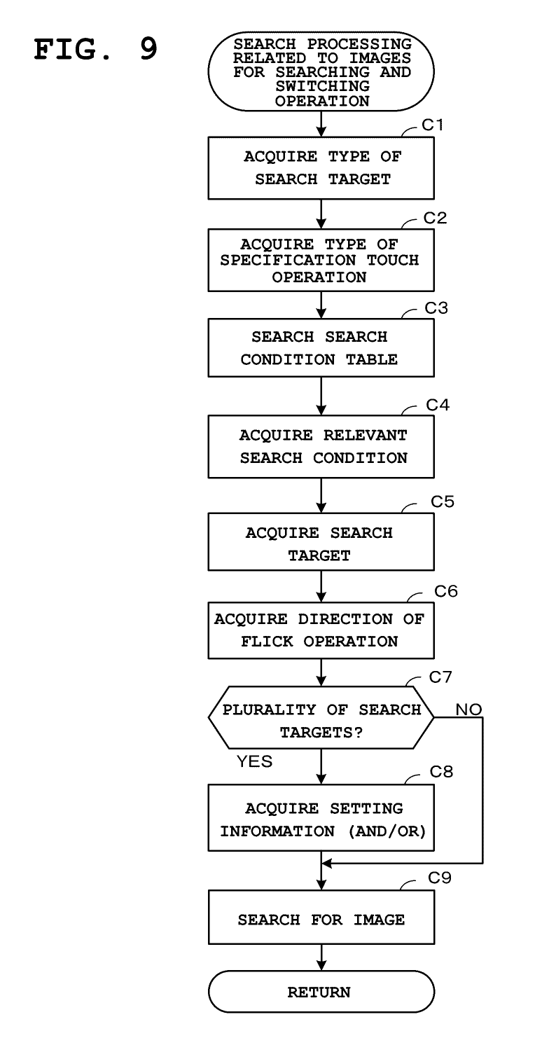

FIG. 9 is a flowchart for describing in detail the search acquisition processing related to images for a searching and switching operation (Step A5 of FIG. 6).

First, the control section 1 acquires, from the work memory 3b, the type of the search target temporarily stored therein (Step C1), and also acquires the type of the specification touch operation (Step C2). Then, by searching the search condition table 3c based on the type of the search target and the type of the specification touch operation (Step C3), the control section 1 acquires a search condition corresponding to “search target type” and “type of specification touch operation” (Step C4). For example, when “search target type” is “face of person”, if “type of specification touch operation” is “touch”, the control section 1 acquires “search for an image arranged in the flick direction and containing the same person”. If “type of specification touch operation” is “upward flick”, the control section 1 acquires “search for an image arranged in the flick direction and containing the same person with a smile”. If “type of specification touch operation” is “downward flick”, the control section 1 acquires “search for an image arranged in the flick direction and containing the same person whose eyes are not closed”.

Next, the control section 1 acquires the search target (display data) from the work memory 3b (Step C5), and acquires the direction of the image switching operation (flick operation) (Step C6). Then, the control section 1 judges whether a plurality of search targets has been acquired as the above-described search target (Step C7). When judged that a plurality of search targets have been acquired (YES at Step C7), the control section 1 acquires information set in advance (AND condition or OR condition) (Step C8). Then, at the next Step C9, the control section 1 searches the stored image group to read out a relevant image(s), based on the acquired search target(s) (display data), search condition, direction of the flick operation, and setting information (AND condition or OR condition). In this searching operation, when the search target is face of person, the control section 1 finds a relevant image (image containing the same person) by analyzing the stored images. However, when the search target is a photographing date and time or photographing place, the control section 1 refers to Exif information added to the stored images and judges, for example, whether the photographing date and time or photographing place is included in that image.

When the processing for acquiring an image(s) for switching (Steps A5 and A6) is ended, the control section 1 displays the acquired image(s) on the display section 6a by switching such that the face of person, photographing date and time, or photographing place of the search target(s) is displayed in a manner to be distinguishable (Step A7). Consequently, one search processing is ended. Hereafter, unless the playback mode is cancelled (NO at Step A8), the control section 1 returns to Step A2 described above and continuously performs the subsequent processing as described in drawings (3), (4), and (5) of FIG. 2 every time a leftward or rightward flick operation is performed. Then, when the playback mode is cancelled (YES at Step A8), the control section 1 exits the flow of FIG. 6. Note that even when the image acquired by the searching and acquiring processing is being displayed, the search target or the type of the specification touch operation can be changed or the search target can be cancelled by a single touch operation, an upward or downward flick operation, a multi-touch operation, or a pinch-in or pinch-out operation.

As described above, in the first embodiment, when a predetermined image switching operation is performed, the control section 1 refers to a result of judgment as to whether a display portion specified in advance by a touch operation has been specified as a search target. When no search target has been specified, the control section 1 performs display control (normal sequential switch processing) by which images sequentially selected in a forward or reverse direction from a stored image group where images have been arranged according to a predetermined criterion are displayed on the display section 6a. When a search target has been specified, the control section 1 acquires a relevant search condition based on the search target with reference to the search condition table 3c, and performs display control (search-switch processing) of searching the stored image group for an image other than the image being displayed based on the search condition, and displaying the found images on the display section 6a. As a result of this configuration, an image switching operation can be performed such that normal sequential switch processing and search-switch processing can be distinguished, and affinity between a normal sequential switching operation (flick operation) and a searching and switching operation (flick operation in which a search target is specified at a touch start point) can be increased, whereby operability when an instruction to display a desired image is given can be significantly enhanced.

Also, when a display portion corresponding to a touched point is predetermined data, the control section 1 specifies this display portion as a search target. As a result of this configuration, a normal sequential switching operation and a searching and switching operation can be distinguished based on whether a display portion specified by a touch operation is predetermined data.

Moreover, based on a display portion specified as a search target, the control section 1 searches a stored image group for an image containing the display portion. As a result of this configuration, it is possible to search for an image with a part in an image specified by a touch operation as a common subject, and it is possible to easily search for an image containing the common image.

Furthermore, when performing an image search, if a predetermined image switching operation is an operation instructing image switching in a forward direction, the control section 1 searches for images arranged in the forward direction. Conversely, if the operation instructs image switching in a reverse direction, the control section 1 searches for images arranged in the reverse direction. As a result of this configuration, it is possible to select a search range in accordance with the user's intention, whereby an efficient search can be made.

Still further, the control section 1 specifies a display portion corresponding to each of a plurality of touched points as a search target, and searches a stored image group for an image containing the plurality of display portions. As a result of this configuration, for example, it is possible to search only for an image containing a plurality of common subjects. In this case, a search may be made for a combination of plural search targets of different types.

Yet still further, when a touch operation is performed on a face portion of a person on an image, the control section 1 specifies the face portion corresponding to the touched point as a search target, and searches for another image containing this face portion. As a result of this configuration, for example, it is possible to search only for a photographed image showing a child, friend, or the like. In this case, when face portions of a plurality of persons are search targets, it is possible to search only for an image showing a group of persons or a family.

Yet still further, the control section 1 acquires a search condition from the search condition table 3c based on the type of a touch operation, and searches a stored image group based on the search condition. As a result of this configuration, various searches can be made only by changing the type of a touch operation.

Yet still further, when a touch operation is performed on a point corresponding to a display portion already specified as a search target, the control section 1 cancels the specification of the search target. As a result of this configuration, even if search target specification is erroneously performed, the error can be easily corrected only by touching that display portion.

Yet still further, when searching a stored image group for an image containing a display portion of a search target for display, the control section 1 causes the display portion to be displayed in a manner to be distinguishable. As a result of this configuration, the user can perform a touch operation while visually recognizing and checking on which display portion of an image a touch operation is performed, whereby erroneous operations can be effectively prevented.

Yet still further, when a flick operation is performed as a touch operation, the control section 1 specifies a display portion corresponding to the touch start point of the flick operation as a search target and takes the direction of the flick operation as part of the search condition. As a result of this configuration, search conditions can be specified in more detail.

In the above-described first embodiment, search targets are “face of person”, “photographing date and time”, and “photographing place”. However, an automobile, a pet, a flower, or the like can be specified as a search target. In addition, color can be specified as a search target.

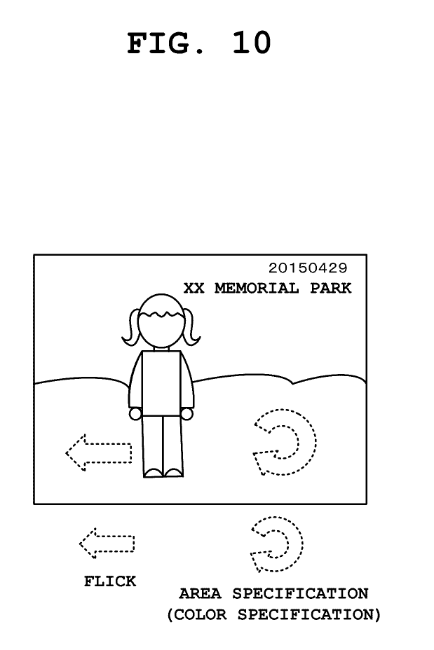

FIG. 10 shows a specification touch operation when color is specified as a search target. In the example depicted in the drawing, in order to specify the color of glass, area specification (color specification) is performed on a glass portion. For this area specification (color specification), a touch operation (slide operation) is performed such that an arc or a rectangular area is drawn, as depicted in the drawing. Note that, in a case where a search is made for an image based on the area-specified color, a search may be made for a thumbnail image in additional information without the compressed image being decompressed. Also, in this area specification, a landscape or a background may be specified.

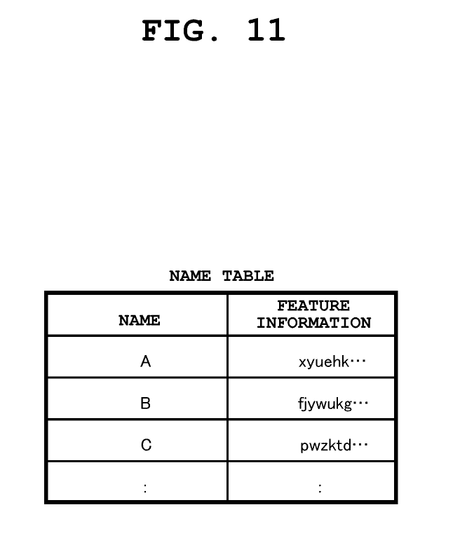

Also, in the above-described first embodiment, a search is made for the same person based on the face. However, in order to make a person identifiable, a name table such as that depicted in FIG. 11 may be provided. This name table stores “name” of a person and “feature information” indicating features of a face image or the face in association with each other. When face of person is a search target, the control section 1 may refer to the name table of FIG. 11 and, if “name” matching “feature information” has been stored, the control section 1 may read out that “name” for additional display on the playback screen displaying the search image.

Moreover, in the above-described first embodiment, in a search for the same person based on the face, stored images are analyzed to make a search for an image containing the same person. Here, in order to increase the image-search speed, feature information regarding each person may be stored in advance in the stored images as additional information (Exif information), or feature information regarding them may be stored in a search table (omitted in the drawings).

Furthermore, in the above-described first embodiment, information regarding a photographing date and time and a photographing place is taken as additional information (Exif information) for a stored image. However, this information regarding a photographing date and time and a photographing place may be stored in a search table (omitted in the drawing).

Still further, in the above-described first embodiment, a flick operation is exemplarily described as a predetermined image switching operation. However, the present invention is not limited thereto. For example, an instruction for image switching may be made by operating a hard key such as a cross key.

Yet still further, in the above-described first embodiment, an additional search condition for narrowing down a search target is added by an upward or leftward flick operation. However, the present invention is not limited thereto, and NOT (negation) indicating that a search target is excluded may be taken as a search condition.

Yet still further, in the above-described first embodiment, for a plurality of search targets, an AND condition or OR condition is taken as a search condition. However, the present invention is not limited thereto and, XOR (exclusive OR) indicating that part of search targets is excluded may be taken as a search condition.

### Second Embodiment

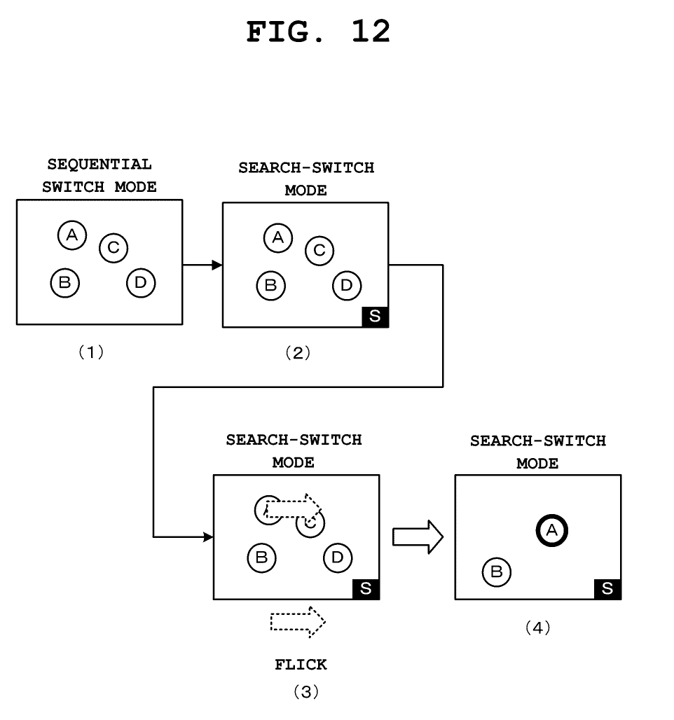

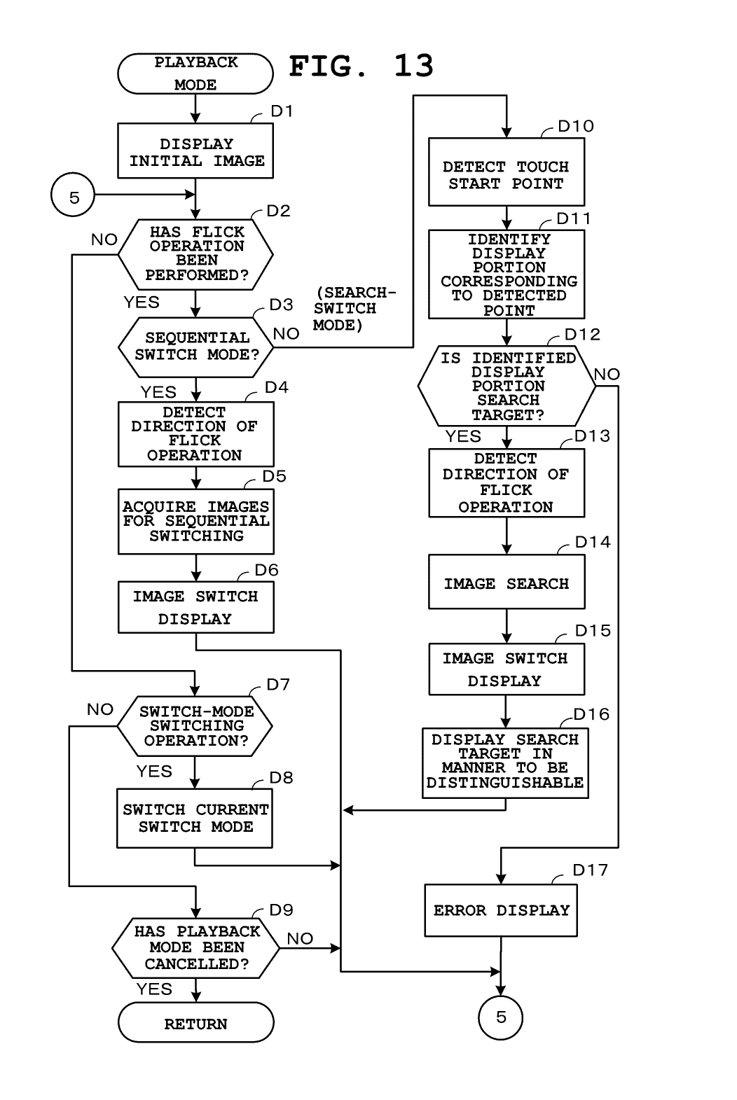

A second embodiment of the present invention is described below with reference to FIG. 12 to FIG. 13.

In the above-described first embodiment, a specification touch operation of specifying a search target is performed, and then a predetermined image switching operation is performed. In the second embodiment, an operation of specifying a search target and an image switching operation can be achieved by one flick operation. Also, a range in a stored image group to be searched can be selected in accordance with the user's intension. Note that sections that are basically the same or have the same name in both embodiments are given the same reference numerals, and therefore explanations thereof are omitted. Hereafter, the characteristic portions of the second embodiment will mainly be described.

FIG. 12 is a diagram outlining an operation in a search-switch mode in the second embodiment.

In the second embodiment, it is possible to arbitrarily switch between a normal sequential switch mode where images sequentially selected in a forward or reverse direction from a stored image group where images have been arranged according to a predetermined criterion are displayed on the display section 6a and a search-switch mode where the stored image group is searched for images other than an image being displayed and the found images are displayed on the display section 6a, by operating a mode switch key.

Drawing (1) of FIG. 12 shows a state where an image showing persons A, B, C, and D is being displayed on the playback screen. Drawing (2) of FIG. 12 represents a display state when the sequential switch mode is switched to the search-switch mode, in which a mark S indicating that switching has been performed to the search-switch mode is additionally displayed at a predetermined point on the playback screen (in the example depicted in the drawing, the lower-right corner). Drawing (3) of FIG. 12 shows a state in which, in order to specify a search target, an image switching operation (flick operation) has been performed with the face portion of a person desired by the user as a touch start point. In the example of the drawing, a flick operation has been performed rightward from the face portion of person A. Drawing (4) of FIG. 12 shows another image displayed in response to the flick operation. The control section 1 searches a stored image group for an image containing person A (persons A and B are contained in the example of the drawing), displays the found image on the playback screen such that the face portion of the touched person A is distinguishable.

FIG. 13 is a flowchart of a characteristic operation in a playback mode in the second embodiment.

First, when a previously displayed image is present, the control section 1 reads out this image from a stored image group where images have been arranged according to a predetermined criterion. When such an image is not present, the control section 1 reads out a head image, displays the read image on the playback screen (Step D1), and judges whether a flick operation has been performed (Step D2). When judged that no flick operation has been performed (NO at Step D2), the control section 1 judges whether an operation for switching the current switching mode has been performed (Step D7), and judges whether a playback mode cancelling operation has been performed (Step D9). Here, when judged that an operation for switching the current switching mode has been performed (YES at Step D7), the control section 1 performs processing of switching between the sequential switch mode and the search-switch mode (Step D8), and then returns to Step D2 described above.

At Step D2 and Step D3, when judged that a flick operation has been performed (YES at Step D2) and the current mode is the sequential switch mode (YES at Step D3), the control section 1 detects the direction of the flick operation (Step D4), searches a stored image group arranged in the flick direction, reads out and acquires an image next to the image being displayed as an image for sequential switching (Step D5), and displays it on the playback screen by switch display (Step D6). Then, the control section 1 returns to Step D2 described above. On the other hand, when judged that a flick operation has been performed (YES at Step D2) and the current mode is the search-switch mode (NO at Step D3), the control section 1 detects the touch start point of the flick operation (Step D10), and identifies a display portion corresponding to the touch start point (Step D11). Then, the control section 1 refers to the search condition table 3c based on the display portion, and judges whether the display portion is a search target based on whether the identified display portion is predetermined date (face of person, photographing date and time, or photographing place) (Step D12).

Here, when the display portion is not a search target (face of person, photographing date and time, or photographing place) (NO at Step D12), the control section 1 performs display indicating the error (message display showing “no search target has been detected) to disenable this flick operation (Step D17), and then returns to Step D2 described above. Conversely, when the display portion is a search target (YES at Step D12), the control section 1 detects the direction of the flick operation (Step D13), searches the stored image group arranged in the flick direction, reads out and acquires an image (image containing the search target) other than the image being displayed as an image for search-switching (Step D14), and displays it on the playback screen by switch display (Step D15). Then, after performing the distinguishable display of the search target (Step D16), the control section 1 returns to Step D2 described above.

As such, when a flick operation is performed in the sequential switch mode, the sequential switch processing is performed. When a flick operation is performed in the search-switch mode, the search-switch processing is performed.

As described above, in the second embodiment, when a flick operation is performed on the touch panel, a display portion corresponding to the touch start point of the flick operation on display data displayed on the display section 6a is specified as a search target, and the forward or reverse direction of a plurality of images arranged according to a predetermined criterion is specified as a search direction based on the direction of the flick operation. Then, based on the display portion, images arranged in the search direction are searched for an image other than an image being displayed, and the found image is displayed. As a result of this configuration, an operation of specifying a search target and an image switching operation can be achieved by one flick operation. In addition, a range in a stored image group to be searched can be selected in accordance with the user's intention. That is, only by performing a flick operation, a search can be made for a desired image, whereby operability when giving an instruction to display a desired image can be significantly enhanced and a search for the desired image can be efficiently made.

Also, when searching a stored image group based on a search target, the control section 1 searches for an image containing the display portion of the search target. Therefore, it is possible to search for another image by taking the display portion corresponding to the touch start point as a common subject, and it is possible to easily search for another image containing the common subject.

Moreover, when a predetermined condition is satisfied (when the current mode is the search-switch mode), the control section 1 performs display control (search-switch processing) such that images arranged in the direction of a flick operation are searched for another image and this image is displayed. When the predetermined condition is not satisfied (when the current mode is the sequential switch mode), the control section 1 performs display control (normal sequential switch processing) such that images sequentially selected in a forward or reverse direction from a plurality of images arranged according to a predetermined criterion are displayed. As a result of this configuration, even with the same flick operation, normal sequential switch processing and the search-switch processing can be performed in a distinguishable manner.

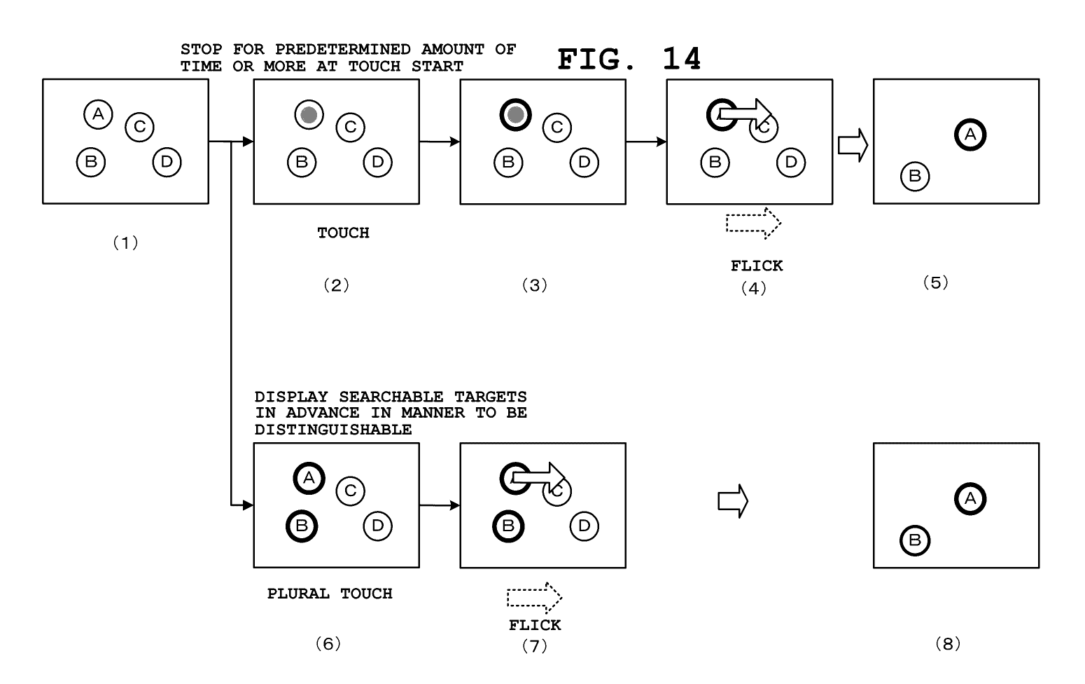

In the above-described second embodiment, the search-switch processing is performed when a predetermined condition is satisfied (when the current mode is the search-switch mode), and normal sequential switch processing is performed when the predetermined condition is not satisfied (when the current mode is the sequential switch mode). However, the predetermined mode is not limited to the switch mode, and may be a mode depicted in FIG. 14.

FIG. 14 is a diagram for describing a modification example of the second embodiment, which is similar to the second embodiment in that an operation for specifying a search target and an image switching operation can be achieved by one flick operation, but is different therefrom in that each predetermined condition is different.

Drawing (1) of FIG. 14 shows the display state of an image containing persons A, B, C, and D, as with drawing (1) of FIG. 12, and drawing (2) of FIG. 14 shows a state where the face portion of person A desired by the user has been touched at the start point of a flick operation. In drawing (3) of FIG. 14, the flick operation has been stopped in the state in drawing (2) of FIG. 14 (at the start point of the flick operation) for a predetermined amount of time (for example, one second) or more. If a display portion corresponding to this start point is a search target, the search target is displayed such that it is distinguishable (for example, thick-frame display).

Drawing (4) of FIG. 14 shows a state where the flick operation has been performed after stopping at the flick start point for the predetermined amount of time or more. In the example depicted in the drawing, the flick operation is a rightward flick operation. When a flick operation is performed as described above, the control section 1, at the start of the flick operation, refers to a timer (omitted in the drawings) that measures time from the start of a flick operation to the end thereof, and judges whether the operation has stopped for the predetermined amount of time or more at that position. When judged that the operation has stopped for the predetermined amount of time or more, the control section 1 judges that a predetermined condition has been satisfied, and performs the search-switch processing. When judged that the operation has not stopped for the predetermined amount of time or more, the control section 1 judges that the predetermined condition has not been satisfied, and performs normal sequential switch processing.

Drawing (5) of FIG. 14 shows a state where an image containing the search target has been retrieved and displayed by the search-switch processing. Here, the search target (face portion of person A) specified at the start of the flick operation has been continuously displayed in a distinguishable manner (thick-frame display). Note that, even if the stop of the flick operation for the predetermined amount of time or more is detected, error display (message display showing “no search target has been detected) is performed to disenable the flick operation when no search target can be specified, as with the second embodiment. As such, by the stop of a flick operation for more than the predetermined amount of time at its starting point being taken as a predetermined condition, a search can be made for a desired image only by performing a flick operation, without an operation of switching the current switch mode. As a result of this configuration, operability when giving an instruction to display a desired image can be significantly enhanced.

Drawing (6) of FIG. 14 shows a state in which predetermined data (face of person, photographing date and time, or photographing place) in an image, that is, pieces of data that are potential search targets are detected when the image is displayed on the playback screen, and then displayed such that they are distinguishable (for example, thick-frame display). In this state where the pieces of data that are potential search targets are being displayed in advance in a manner to be distinguishable, the user performs a flick operation with any one of the pieces of data displayed in a distinguishable manner as the start point of the flick operation so as to specify a desired search target. Drawing (7) of FIG. 14 shows a state in which the user-desired search target (face portion of person A) has been touched as the start point of the flick operation. In the example depicted in the drawing, the flick operation is a rightward flick operation.

When the flick operation is to be performed as described above, the control section 1 judges, at the start of the flick operation, whether the flick operation has been performed from the position of a search target displayed in a distinguishable manner. When judged that the flick operation has been started from the position of a search target displayed in a distinguishable manner, the control section 1 judges that the predetermined condition has been satisfied, and performs the search-switch processing. When judged that the flick operation has not been started from the position of a search target displayed in a distinguishable manner, the control section 1 judges that the predetermined condition has not been satisfied, and performs normal sequential switch processing.

Drawing (8) of FIG. 14 shows a state in which an image containing the search target has been retrieved and displayed by the search-switch processing. Here, the search target (face portion of person A) specified at the start of the flick operation has been continuously displayed in a distinguishable manner (thick-frame display). Note that, when no search target is in the image being replayed, normal sequential switch processing may be performed. As such, by the fact that a flick operation has been started from the position of a search target being taken as a predetermined condition, a search can be made for a desired image only by the flick operation. As a result, operability when giving an instruction to display a desired image can be significantly enhanced.

In the above-described second embodiment and its modification example depicted in FIG. 14, one search target is specified at the start of a flick operation. However, a plurality of search targets may be specified by a multi-touch flick operation.

Also, in each of the above-described embodiments, the present invention has been applied in an imaging apparatus (digital camera) as an image display apparatus. However, the present invention is not limited thereto. For example, the present invention can be applied in a personal computer, a PDA (Persona Digital Assistant), a tablet terminal apparatus, a portable telephone such as a smartphone, an electronic game machine, a music player, or the like as an image display apparatus.

Moreover, the “apparatuses” and “sections” described in the above-described embodiments are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. An image display apparatus equipped with a touch input section having a touch panel and a display section which displays an image, comprising:
a processor that is configured to:
acquire a touched point when a touch operation is performed on the touch panel;
identify a display portion corresponding to the acquired touched point in display data displayed on the display section, as a search target;
judge whether a search target has been identified when a predetermined image switching operation is started;
perform display control in response to the predetermined image switching operation such that images sequentially selected in a forward or reverse direction from a plurality of images arranged according to a predetermined criterion are displayed on the display section, when a judgment is made that no search target has been identified; and
perform display control in response to the predetermined image switching operation such that another image other than the image being displayed is searched for from the plurality of images based on the identified display portion and displayed on the display section, when a judgment is made that a search target has been identified.

2. The image display apparatus according to claim 1, wherein the processor identifies the display portion as the search target when the display portion corresponding to the touched point is predetermined data.

3. The image display apparatus according to claim 1, wherein the processor, when searching the plurality of images for another image based on the display portion identified as the search target, searches for an image containing the display portion.

4. The image display apparatus according to claim 1, wherein the processor, when searching the plurality of images arranged according to the predetermined criterion for another image based on the display portion identified as the search target, searches for an image arranged in the forward direction if the image switching operation is an operation giving an instruction to perform image switching in the forward direction, or searches for an image arranged in the reverse direction if the image switching operation is an operation giving an instruction to perform image switching in the reverse direction.

5. The image display apparatus according to claim 1, wherein the processor (I) identifies, when a plurality of touched points are acquired, a plurality of display portions corresponding to the plurality of touched points as a plurality of search targets, and (ii) searches the plurality of images for an image containing the plurality of display portions when a judgment is made that the plurality of search targets have been identified.

6. The image display apparatus according to claim 1, wherein the processor, when a touch operation is performed on a face portion of a person in image data displayed on the display section, identifies the face portion subjected to the touch operation as a search target, and searches for another image containing the face portion when searching the plurality of images for another image.

7. The image display apparatus according to claim 1, wherein the processor (i) detects a type of the touch operation performed on the touch panel, (ii) acquires a search condition for searching for the search target based on the detected type of the touch operation, and (iii) searches the plurality of images for another image based on the acquired search condition, when a judgment is made that the search target has been identified.

8. The image display apparatus according to claim 1, wherein the processor, when a touch operation is performed on a point corresponding to a display portion already identified as a search target, cancels identification of the search target.

9. The image display apparatus according to claim 1, wherein the processor, when searching the plurality of images for an image containing the display portion of the search target based on the display portion identified as the search target and displaying the image on the display section, performs display control such that the display portion in the found image is displayed in a manner to be distinguishable.

10. The image display apparatus according to claim 1, wherein the processor (i) detects a direction of a flick operation performed as the touch operation, (ii) identifies a display portion corresponding to an acquired touch start point of the flick operation, as the search target, and (iii) makes a search with the detected flick direction as part of a search condition when searching the plurality of images for another image based on the identified display portion.

11. An image display apparatus equipped with a touch input section having a touch panel and a display section which displays an image, comprising:
a processor that is configured to:
acquire a touch start point when a flick operation is performed on the touch panel;
cause a display portion serving as a search target candidate in display data displayed on the display section to be displayed in a distinguishable manner; and
search a plurality of images arranged according to a predetermined criterion in a search direction based on a flick direction of the flick operation with the display portion displayed in the distinguishable manner as a search target, when the acquired touch start point of the flick operation is the display portion displayed in the distinguishable manner.

12. The image display apparatus according to claim 11, wherein the processor searches the plurality of images for an image containing the display portion based on the display portion displayed in the distinguishable manner.

13. The image display apparatus according to claim 11, wherein the processor sets whether or not to make a search, and performs display in the distinguishable manner when the search is set to be performed.

14. A display control method for an image display apparatus equipped with a touch input section having a touch panel and a display section which displays an image, comprising:
acquiring a touched point when a touch operation is performed on the touch panel;
identifying a display portion corresponding to the acquired touched point in display data displayed on the display section, as a search target;
judging whether a search target has been identified when a predetermined image switching operation is started;
performing display control in response to the predetermined image switching operation such that images sequentially selected in a forward or reverse direction from a plurality of images arranged according to a predetermined criterion are displayed on the display section, when a judgment is made that no search target has been identified; and
performing display control in response to the predetermined image switching operation such that another image other than the image being displayed is searched for from the plurality of images based on the identified display portion and displayed on the display section, when a judgment is made that a search target has been identified.

15. A display control method for an image display apparatus equipped with a touch input section having a touch panel and a display section which displays an image, comprising:
acquiring a touch start point when a flick operation is performed on the touch panel;
causing a display portion serving as a search target candidate in display data displayed on the display section to be displayed in a distinguishable manner; and
searching a plurality of images arranged according to a predetermined criterion in a search direction based on a flick direction of the flick operation with the display portion displayed in the distinguishable manner as a search target, when the acquired touch start point of the flick operation is the display portion displayed in the distinguishable manner.
